(19) United States
(12) Patent Application Publication
(10) Pub. No.: US 2003/0019744 A1
(43) Pub. Date: Jan. 30, 2003

(54) Substrate holder

(76) Inventor: Joachim Pokorny, Hufingen (DE)

Correspondence Address: Robert W Becker & Associates, Suite B, 707 Highway 66 East, Tijeras, NM, 87059-7382, US

(21) Appl. No.: 10/169,058

(22) PCT Filed: Dec. 8, 2000
(86) PCT No.: PCT/EP00/12429

(30) Foreign Application Priority Data
Dec. 22, 1999 (DE) 19962170.5

(51) Int. Cl. C25C 7/00; C25F 7/00; B23H 7/26

(52) U.S. Cl. 204/297.01

(57) ABSTRACT

The invention relates to a substrate holder (1) for holding substrates (5), especially semiconductor wafers. The inventive holder comprises first and second components (3, 4). The substrate (5) can be received between said components. The invention is characterized in that the first component (3) is provided with a base body (7) and at least one support element (70) which can be moved in relation to said body and is elastically pre-stressed in the direction of the second component (4).

The invention relates to a substrate holder for holding substrates, especially semiconductor wafers, with first and second components between which the substrate can be received.

Such a substrate holder is described, for example, in the not prepublished German application Nr. 198 59 467, which originates with the same applicant. The substrate holder is particularly suitable for holding the semiconductor wafer during a metal plating, during which a surface that is to be plated is exposed relative to an electrolyte, whereas the rest of the wafer is sealed off relative to the electrolyte. To provide this sealing effect, a circumferential seal is provided on a portion of the substrate holder and is pressed against the wafer when it is clamped in the substrate holder.

In this connection, the dimensions of the two components of the substrate holder, and the shape and position of the seal, are such that at a certain wafer thickness a good seal is achieved. With substrates having different thicknesses, the sealing effect varies, since a spacing between the seal and a counter surface that is disposed across from the seal and between which the wafer is received, is essentially fixedly prescribed. An incomplete sealing effect can, however, lead to a situation during the plating of the wafer that electrolyte reaches and damages those regions of the wafer that are not to be plated.

The seal is furthermore provided with an undercut that enables an electrical contact of the surface of the wafer that is to be plated. This contact is achieved by a plurality of essentially radially extending contact springs having rounded contact ends that extend into the region of the undercut and are elastically pre-tensioned against the wafer surface. By applying a voltage between the surface of the wafer that is contacted by the contact springs, and a counter electrode that extends parallel to the wafer, the metal plating is enhanced.

However, due to the arrangement of the individual contact springs, the problem results that no homogeneous electrical field is generated upon the wafer surface, which results in a non-uniform metal deposition. For this reason, it is expedient to provide an annular electrode that radially surrounds the wafer and via which a homogenization of the electrical field is achieved. In this connection, the radial spacing between electrode and wafer should be kept as small as possible for a homogeneous field.

Proceeding from the above apparatus, it is an object of the present invention to provide a substrate holder of the aforementioned type that, independently of the substrate thickness, enables a uniform accommodation, especially a uniform clamping effect, between the two substrate components. It is a further object of the invention to reduce the radial dimension of the substrate holder in the region of the wafer.

This object is inventively realized with a substrate holder of the aforementioned type in that the first component is provided with a base body and at least one first support element that is movable relative thereto, and that is elastically pre-tensioned in a direction toward the second component. As a result, substrates having different thicknesses can be received between the two components of the substrate holder at essentially the same clamping effect.

Pursuant to a particularly preferred embodiment of the invention, at least one spring is provided between the base body and the first support element in order to achieve the elastic pre-tension.

To ensure a precise positioning of the substrate that is disposed upon the first support element, at least one guide element is provided for guiding the base body and/or the first support element during the relative movement. At least one abutment is preferably provided that limits the relative movement between base body and first support element.

Pursuant to a particularly preferred embodiment of the invention, the first support element is a support plate having a support surface that is adapted to the substrate, as a result of which an essentially continuous support of a substrate surface is provided. In this connection, the support surface is preferably roughened to prevent a vacuum from forming between the substrate and the support surface that would make it difficult to release the substrate from the support plate.

Pursuant to a particularly preferred embodiment of the invention, at least one second support element is provided that is movable relative to the base body and to the first support element, and that is elastically pre-tensioned in the direction of the second component. The second support element enables a relative movement of a support element that rests thereon relative to the base body and to the first support element in order to space it therefrom and to facilitate the access of a handling device. For this purpose, the second support element is preferably movable into a first position in which its support surface is disposed over the support surface of the first support element.

To ensure a planar support of the substrate upon the first support surface, the second support element is preferably movable into a position in which its support surface is disposed below the support surface of the first support element.

For a uniform positioning of the first and second support elements relative to one another, the second support element is preferably guided in an opening of the first support element. A device for limiting the relative movement between the second support element and the base body and/or the first support element is also preferably provided in order to ensure uniform movement processes.

The support surface of the second support element is preferably smaller than that of the first support element in order to provide as uniform as possible of a support of the substrate by the first support element.

To reliably hold the substrate upon the second support element, at least one suction opening is provided in the support surface of the second support element.

Pursuant to one embodiment of the invention, the second component of the substrate holder has a central opening that is adapted to the shape of the substrate in order to expose a portion of the substrate surface that faces the second component. In this connection, only a rim region of the substrate surface is preferably covered by the second component of the substrate holder, and preferably a sealing element that faces the substrate and surrounds the central opening is provided on the second component in order to seal the exposed surface region relative to the remaining surface regions of the substrate.

For a reliable retention of the two components of the substrate holder against one another a sealing or locking mechanism is preferably provided. Pursuant to a preferred embodiment of the invention, the locking mechanism is provided with a rotatable locking element on one component, and a receiving means on the other component for receiving the locking element. The locking element is preferably pre-tensioned into a locking position by at least one spring, and is movable against the pre-tension by an actuating mechanism, so that an automatic locking of the two components is achieved upon release of the actuating mechanism. An inclined locking surface is advantageously provided on the locking element and/or on the receiving means in order to draw the two components toward one another during a relative movement between locking element and receiving means.

In order in addition to the locking function to control a movement of the second support element, the locking element is provided with at least one holding part for holding and releasing the second support element. The second support element is preferably movable against its pre-tension by relative movement between the holding part and the second support element in order in a simple way to control the movement of the second support element.

At least one sealing element is preferably provided between the two components of the substrate holder in order to seal the surface regions of the substrate that are enclosed between the substrate holders relative to the environment. The substrate holder is preferably provided with at least one contact device for the electrical contacting of the surface of the substrate that faces the second component, in order to enable a metal plating of the exposed substrate surface.

The inventive object is realized by a substrate holder for holding substrates, especially semiconductor wafers, and including first and second components between which a substrate can be received, and including at least one contact element for the electrical contacting of a surface of the substrate, which contact element has a connection end, a contact end that is remote therefrom and overlaps the substrate, and a connecting part between the ends, in that the connecting part is guided along an outer periphery of the substrate, and essentially perpendicular to the substrate surface that is to be contacted, by a guide means, and the contact end is elastically pre-tensioned in the direction of the substrate surface. In so doing, the radial dimensions of the substrate holder in the region of a substrate received therein can be kept small in order to enable the arrangement of an annular electrode that radially surrounds the substrate.

In this connection, the connecting part is preferably movable parallel to the guide means, and the contact element is elastic at least in a region between the connection end and the guide means in order to provide an elastic spring effect at a site remote from the contact end.

The contact element is preferably carried in a base body and forms with it a contact block, whereby the guide means is preferably a portion of the base body in order to provide a good and defined positioning of the contact element. A plurality of contact elements are preferably provided in a contact block in order to provide a plurality of contact points upon the substrate, and hence a reliable electrical contacting of the substrate. In this connection, the connection ends of the contact elements are preferably connected to a common contact part in order to provide a uniform electrical contacting of all contact elements.

For a particularly good electrical contacting of the substrate, a plurality of contact blocks are disposed about the outer periphery of the substrate. In so doing, at least two electrical lines are preferably provided for contacting the contact parts of the contact blocks such that each second contact block is connected with one line and the remaining contact blocks are connected with the other line. This alternating contacting enables a measurement of resistance over the two lines in order to be able to establish the quality of the contact.

The invention will be explained subsequently with reference to the figures. Shown are:

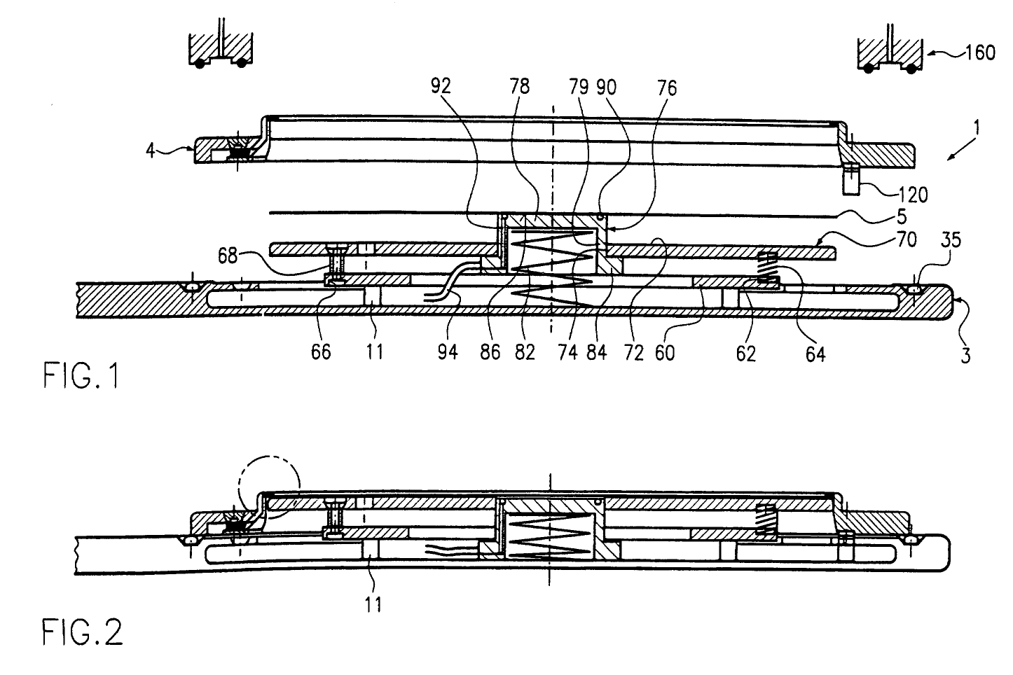

FIG. 1 a schematic cross-sectional view of one inventive substrate holder in an opened position;

FIG. 2 a schematic cross-sectional view of the inventive substrate holder in a closed position;

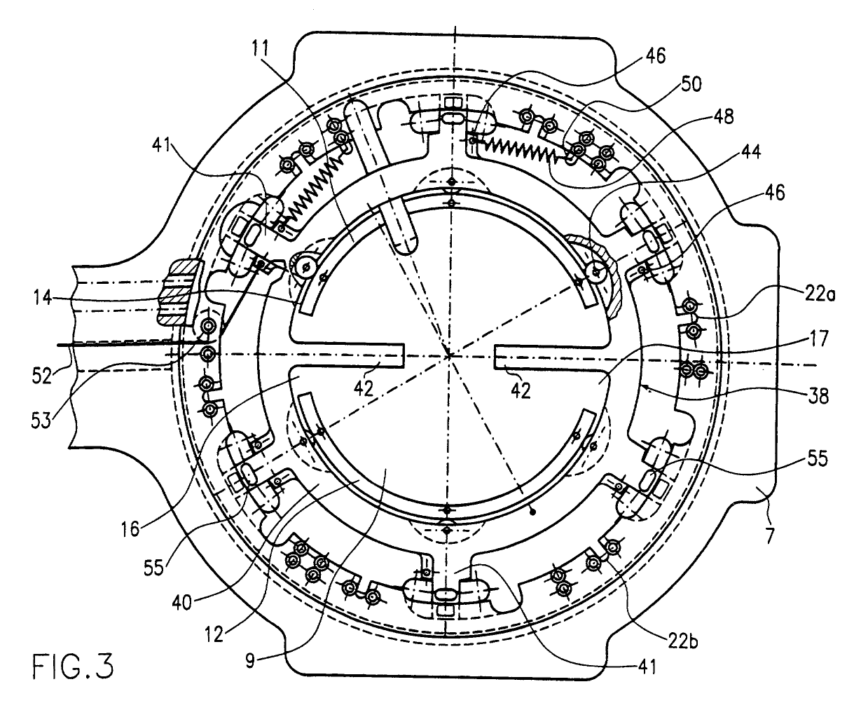

FIG. 3 a schematic plan view upon a first component of the substrate holder, whereby for simplification of illustration some of the elements are omitted;

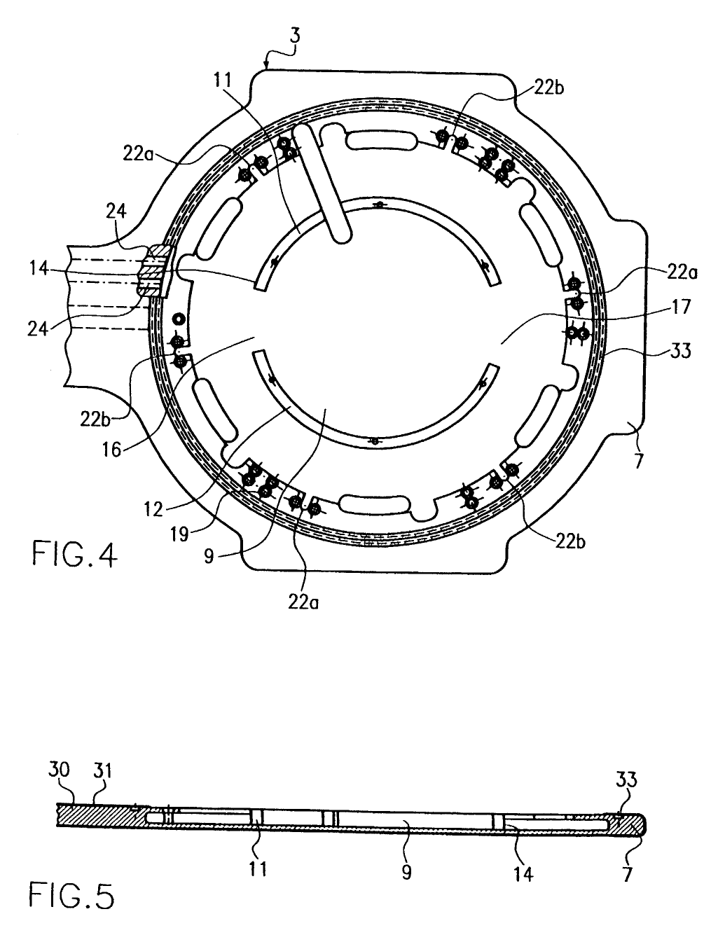

FIG. 4 a view similar to that of FIG. 3, whereby still further parts are omitted;

FIG. 5 a schematic cross-sectional view of the component of FIG. 4;

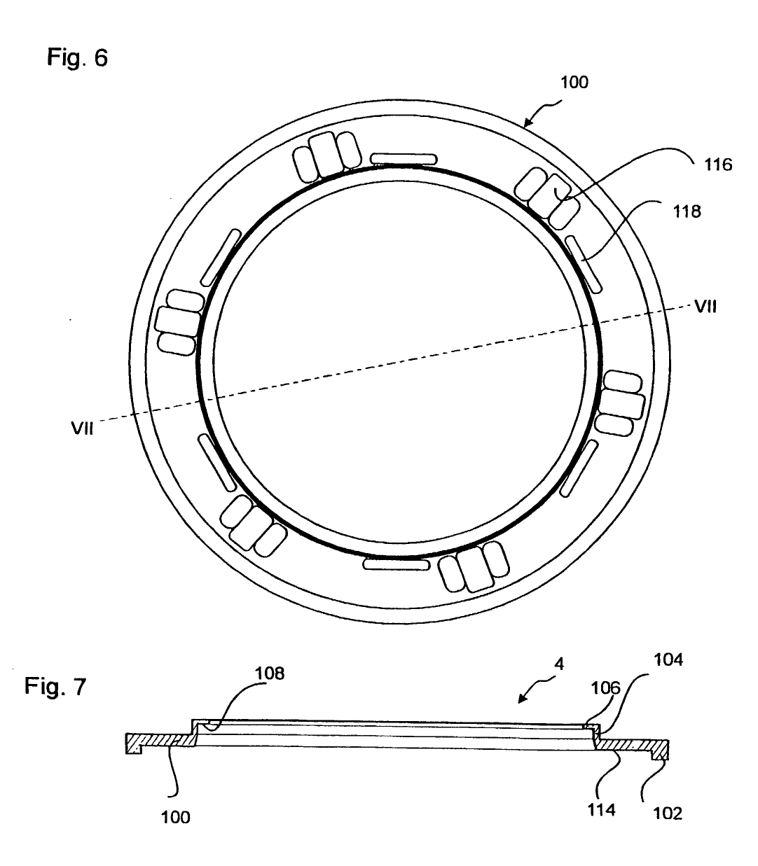

FIG. 6 a schematic view from below upon a second component of the substrate holder of the present invention, whereby for simplification a number of elements have been omitted;

FIG. 7 a schematic cross-sectional view taken along the line VII-VII in FIG. 6;

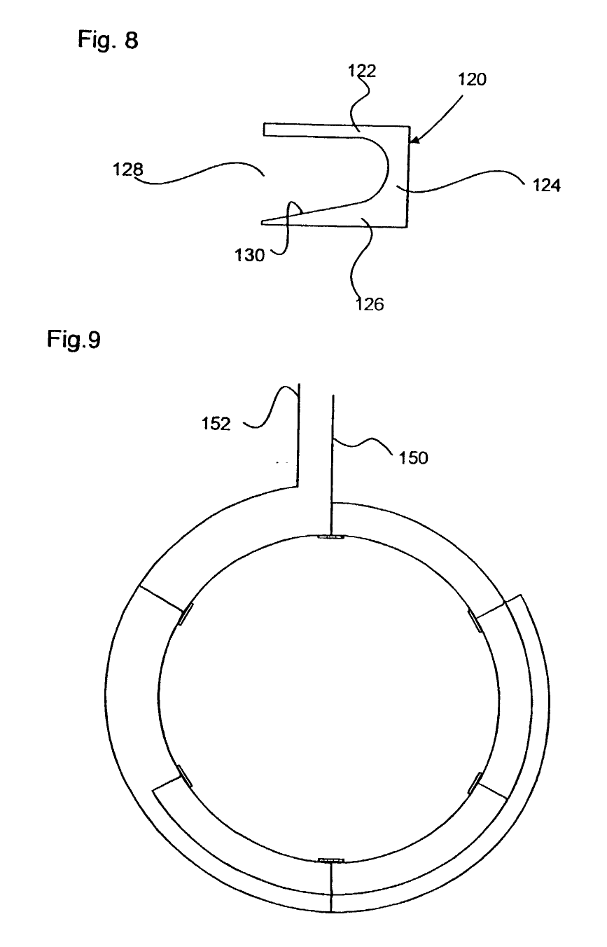

FIG. 8 an enlarged cross-sectional detail view of a locking element-receiving portion pursuant to the present invention;

FIG. 9 a schematic illustration of the arrangement of contact elements upon a substrate surface, as well as the electrical contacting thereof;

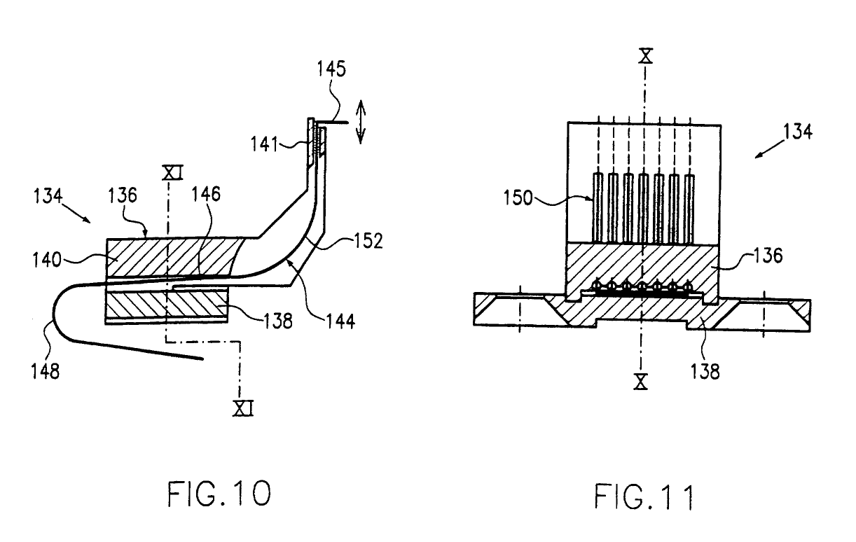

FIG. 10 a schematic cross-sectional illustration of a contact block pursuant to the present invention;

FIG. 11 a schematic cross-sectional illustration of the contact block of FIG. 10 taken along the line XI-XI in FIG. 10;

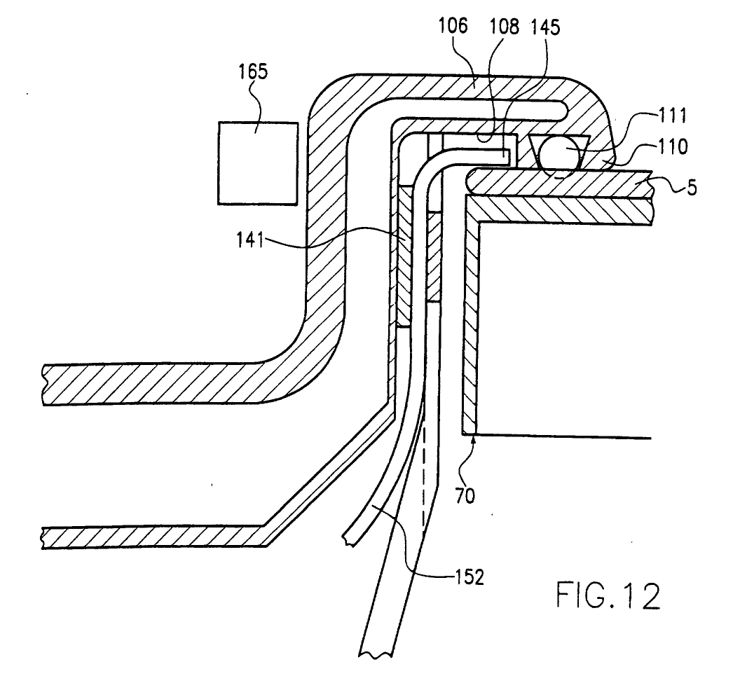

FIG. 12 an enlarged detailed view of the portion of the inventive apparatus encircled in FIG. 2.

FIG. 1 shows a substrate holder 1 having a lower component 3 and an upper component 4, between which a substrate 5 can be received. The lower component 3, which can be seen best in FIGS. 3 to 5, is provided with a main or base body 7 in the form of a plate. Disposed in the base body 7 is a round recess 9 that serves to accommodate a locking or sealing mechanism, as will be explained in greater detail subsequently. Provided in the region of the recess 9 are two guide walls 11,12 in the form of two ring segments that face one another and that form a round guide surface 14 that is interrupted by two openings 16,17. The function of the round guide surface will be explained in greater detail subsequently with reference to FIG. 3.

Provided in the base body 7 are guide openings 19 in which can be inserted, for example, a guide pin disposed on the upper component in order during the bringing together of the upper component and the lower component that a centering of the two components relative to one another is ensured. It is, of course, also possible to provide a guide pin on the lower component and a guide opening on the upper component, or to provide other centering devices on the upper and/or lower components.

Six contact elements 22a and 22b are provided in the region of the recess. The contact elements 22a and 22b are alternatingly disposed in an outer region of the recess 9 at an angular spacing of 60°. The contact elements 22a are connected to a common electrical line, and the contact elements 22b are similarly connected to a common electrical line that differs from the common electrical line for the contact elements 22a.

As can be seen in FIG. 4, provided in the base body 7 are bores 24 that communicate with the recess 9 in order to receive, for example, a vacuum line or an electrical line and to introduce it into the region of the recess 9.

Radially outwardly of the recess 9 the base body 7 is provided with an essentially planar surface 30 that is provided with a coating 31 that is resistant to the chemicals used during a treatment of a substrate. A groove 33 that radially surrounds the recess 9 is provided in the surface 30 for receiving an O-ring 35.

As mentioned previously, the recess 9 serves for the at least partial accommodation of a sealing or locking mechanism 38, which can be seen best in FIG. 3.

The locking mechanism 38 has an annular body 40 with six radially outwardly projecting locking arms 41, as well as two radially inwardly extending holding arms 42. The annular body 40 has an inner periphery that is slightly greater than the round guide surface 14 that is formed by the walls 11,12. Disposed in the annular body 40 are six inwardly directed guide rollers 44 that contact the guide surfaces 14 and thus rotatably guide the annular body 40 in the recess 9.

The locking arms 41 are uniformly arranged about the outer periphery of the annular body 40. Each of the locking arms 41 has a recess for the attachment of one end of a tension spring 48, of which in FIG. 3, to simplify the drawing, only two are shown. The other end of the tension spring 48 is received in a suitable receiving means 50 on the base body 7, so that the annular body 40 is pre-tensioned in one direction of rotation. Pursuant to FIG. 3, the annular body 40 is pre-tensioned for rotation in the clockwise direction. By means of a draw cable 52, which is mounted in a suitable manner on one locking arm 41, the annular body 40 can be moved counter to the spring tension.

The draw cable 52 is introduced via one of the bores 24 into the region of the recess 9, and is deflected about a guide roller 53.

In a radially outer region of the locking arms 41, respective locking rollers 55 are provided for the contact with a locking counter element on the upper component 4, which will be described in greater detail subsequently with reference to FIG. 8.

The holding arms 42 extend radially inwardly through the openings 16,17 between the walls 11,12 and are rotatable with the annular body 40 and are therefore also pre-tensioned in the clockwise direction by the springs 48. The function of the holding arms 42 will be explained in greater detail subsequently.

With reference to FIG. 1, in which for reasons of clarity the locking mechanism 38 has been omitted, the further construction of the lower component 3 will be described. A ring or annular plate 60 is secured on the walls 11,12, of which only the wall 11 can be seen in FIG. 1. With the presently preferred embodiment of the invention, the annular plate 60 is screwed securely in place on the walls 11,12. In an upper side of the annular plate 60 spring receiving means 62 are provided for receiving compression springs 64, one of which is illustrated in FIG. 1. On the whole, six compression springs 64 are uniformly distributed about the circumference of the annular plate 60. In an angular arrangement between the respective spring receiving means, the annular plate 60 is provided with guide openings 66 for receiving guide pins 68. The guide pins 68 are vertically movable in the guide openings 66.

Disposed above the annular plate 60 is a substrate-support plate, which on its underside is provided with receiving openings for receiving the compression springs 64. The compression springs 64 extend between the annular plate 60 and the substrate-support plate 70 and press the substrate-support plate 70 upwardly away from the annular plate 60. The guide pins 68 are secured to the substrate-support plate 70, which is thus laterally guided relative to the annular plate 60. The guide pins 68 furthermore limit the movement of the substrate-support plate away from the annular plate 60.

The support plate 70 has a rough surface 72, against which the one side of the substrate 5 rests when the substrate holder 1 is closed. The surface 72 is roughened to prevent the formation of a vacuum between the wafer 5 and the surface 72.

The support plate 70 has a size and shape that corresponds to the wafer 5, and has a central opening 74. Received in the central opening 74 is a movable platform 76. The platform 76 is formed by an upper wall 78 and side walls 79 that extend perpendicularly downwardly, so that the platform 78 has the shape of an upside down U. A compression spring 82 extends between a base of the base body 7 and the upper wall 78, and presses the platform upwardly. An upwardly directed movement of the platform 76 is delimited by radially outwardly extending flanges 84 on the side walls 79 that come into engagement with a backside of the substrate-support plate 70.

The upper side of the upper wall 78 forms a substrate-support surface 86. Formed in the upper side 86 is an annular groove 90 that via a bore 92 in the side wall 79 and flange 84, and via an appropriate line 94, is in communication with a vacuum source in order to draw in the wafer 5 that rests upon the upper side 86 and to securely hold it thereon.

As can be seen in FIG. 1, the upper side 86 of the platform 76 is disposed above the upper side 72 of the substrate-support plate 70, so that the wafer 5 is held at a distance from the substrate-support plate 70. This makes it possible for a substrate-handling device to move between the substrate 5 and the support plate 70 and to receive the substrate and transport it away. In the reverse manner, a wafer 5 can also be deposited upon the platform 76.

The upper component 4 of the substrate holder 1 has an annular body 100, as can be best seen in FIGS. 6 and 7. A downwardly extending flange 102 is provided in the radially outer region of the annular body 100. In a radially inner region of the annular body 100 there is provided an upwardly extending flange 104, on the upper end of which is provided a radially inwardly extending flange 106.

As can be seen in the enlarged detail view of FIG. 12, provided on an underside 108 of the flange 106 is a seal receiver 110 for receiving an O-ring 111. The seal receiver 110 is provided on the radially innermost region of the flange 106.

As can be seen in the view of FIG. 6, provided in an underside 114 of the annular body 100 are six contact block receivers 116 for contact blocks, which will be described in greater detail subsequently, as well as for six locking element receivers 118 for receiving a locking element, which will be described in greater detail subsequently. The contact block receivers 116 are uniformly provided in the peripheral direction on the annular body 100, i.e. are respectively provided at a 60 degree angular spacing. The locking element receivers 118 are provided in a similar manner with a 60 degree angular spacing in the circumferential direction.

Locking elements 120, of which one is illustrated in FIG. 1, are received in a suitable manner in the receivers 118 and are secured on the annular body 100. FIG. 8 shows an enlarged cross-sectional view through a locking element 120. The locking element 120 essentially has the shape of a U that is disposed on its side, with an upper wall 122, an end wall 124, as well as a lower wall 126. The upper wall 122 is at least partially accommodated in the receiver 118 in such a way that an opening 128 of the U shape is directed in the circumferential direction, and in particular opposite to the direction of rotation of the locking unit 38 on the lower component 3. An upper side of the lower wall 126 forms an inclined contact or rolling surface 130 upon which the locking rollers 55 of the locking mechanism 38 run during a relative movement between them when the upper component 4 is locked on the lower component 3, as will be described in greater detail subsequently.

FIGS. 10 and 11 show a contact block 134 that is accommodated in the receivers 116 of the annular body 100. The contact block 134 has a base body 136 of insulating material, and a mounting plate 138, which is also made of insulating material. The base body 136 is provided with a main portion 140 as well as a guide portion 141 that is spaced therefrom, as can be seen best in FIG. 10. The contact block 134 is provided with seven substrate-contact springs 144 having a contact end 145 and a connection end 146. The connection ends 146 are clamped in between the base body 136 and the main portion 140, and are pressed against a common connection contact spring 148.

The base body 136 is provided with slots 150 in which is movably guided a central portion 142 of the substrate-contact spring 144. The contact end 145 of the substrate-contact spring 144 extends at right angles to a section of the central portion 152 of the spring that is disposed in the guide 141. By means of the guide 141, the contact end 145 is vertically guided so as to be movable up and down, as illustrated by the double arrow in FIG. 10. The contact end 145 is relatively rigid, and itself is not flexible. By means of the central portion 152, the contact end 145 is pre-tensioned downwardly.

As previously mentioned, the contact block 134 is secured in a suitable manner to the upper component 4 and serves for the electrical contact of one side of the wafer 5, as illustrated in the detail view of FIG. 12. FIG. 12 shows that the guide 141 extends essentially perpendicular to the main surface of the wafer 5, and thus enables a parallel movement, relative to the wafer 5, of the contact end 145, which extends perpendicular to the guide.

It is to be noted that six contact blocks 134 are provided on the upper component 4 in order to enable an electrical contact of a wafer surface at a number of points. In the closed state of the substrate holder, the connection contact springs 148 come into contact with the contact elements 22a and 22b, as a result of which three of the contact blocks are connected with a first line 150, and the remaining three contact blocks are connected with a second line 152 as can be seen in the schematic view of FIG. 9. In this connection, a respective contact block that is connected with the line 150 is disposed between two contact blocks that are connected with the line 152 and vice versa. By measuring a resistance between the two lines, it is now possible to establish the quality of the contact with the substrate surface. For a treatment of a substrate, both lines are connected in parallel and serve in common as a current-supplying connection to the substrate.

With the aid of the figures, and in particular with the aid of FIGS. 1 and 2, the loading and unloading of the substrate holder 1 will now be explained in greater detail.

FIG. 1 shows the substrate holder 1 in an open position, with the upper component 4 being held at a distance above the lower component 3 by means of a vacuum holding device 160. The substrate-support plate 70 as well as the platform 76 are moved away from the base body 7 of the lower component 3 by means of their respective springs 64,82. An upper side 86 of the platform 76 is disposed above a support surface 72 of the substrate-support 70, and a semiconductor wafer 5 is placed upon the upper side 86 in such a way that a surface of the wafer 5 that is to be plated faces upwardly. The wafer 5 is securely held upon the upper side 86 by means of a vacuum that is applied to the annular groove 90.

Proceeding from this position, the upper component 4 is now moved vertically downwardly by the holding device 60 until the contact ends 145 of the contact springs 144 contact an upper surface of the wafer 5. By means of a further, downwardly directed movement, the contact end 145 is moved vertically upwardly relative to the guide 141 of the base body 136, and in particular against the spring force produced by the central portion 152. As a result, the contact end 145 is pulled elastically against the upper surface of the wafer 5.

Subsequently, the seal 111 on the upper component 4 comes into contact with the upper surface of the wafer 5.

The upper component 4 is moved still further downwardly to the lower component 3, as a result of which the wafer 5 now presses the platform 76 downwardly against its spring pre-tension until the underside of the wafer rests upon the support surface 72 of the substrate support. The upper component 4 is moved still further out of this position in the direction of the lower component 3 until the flange 102 of the upper component 4 rests upon the O-rings 35 of the lower component 3. In so doing, the platform 76 and the substrate-support plate 70 are moved together downwardly against their pre-tension. Due to the spring pre-tension, especially of the support plate 70, the rim portions of the wafer 5 are pressed elastically against the seal 111, and in particular with an essentially uniform pressure, independently of the thickness of the wafer 5, and thereby a constant sealing effect is provided in this region.

During the closing movement described above, the locking mechanism 38 is in an open position due to a pulling force exerted upon the draw cable 52. The locking elements 120 on the upper component 4 are moved into the region of the recess 9 in the base body 7 of the lower component 3. The draw cable 52 is subsequently loosened, so that the locking mechanism 38 rotates into its locking position. In so doing, the locking rollers 55 of the locking arms 41 come into contact with the inclined rolling surface 130 of the locking element 120, as a result of which the upper component 4 is pulled tightly against the lower component 3 and is hence locked.

At the same time, the holding arms 42 come into engagement with corresponding contact or rolling surfaces on the platform 76, as a consequence of which the platform 76, counter to its spring pre-tension, is moved away from the back side of the wafer 5, whereby at this point in time a normal pressure exists in the annular groove 90. This ensures a uniform support of the wafer 5 upon the support surface 72.

The upwardly exposed surface is subsequently brought into contact with a liquid electrolyte in order to undertake a metal plating. A metal plating apparatus, in which the above described substrate holder can be placed, is described, for example, in the aforementioned patent application of the applicant, which to this extent is made the subject matter of the present invention.

During the metal plating, by means of the contact springs 144 a voltage is applied between the surface of the substrate 5 and an electrode that is disposed remote therefrom, whereby the upper side of the wafer 5 forms a cathode, while the remote electrode forms an anode.

To achieve a homogeneous electrical field over the substrate surface, a cathode ring 165 is provided that surrounds the upper component 4 of the substrate holder, as shown in FIG. 12.

Although the invention has been described with the aid of preferred embodiments, it is not limited to the special illustrated embodiments. For example, it is not necessary to move the platform 76 away from the substrate as long as the spring 82 is not so strong that the platform effects a bending or flexure of the wafer 5. Furthermore, instead of a single platform 76, a plurality of support pins could be provided that form, for example, a three-point support and that extend through the support plate. The support pins could each be pre-tensioned individually or via a common connecting element and appropriate springs. Individual support pins would have the advantage that a suctioning of the wafer can be eliminated, since a tilting thereof would not be of concern. Furthermore, the support surface of the pins would be held to a minimum relative to the support surface of the plate 70. In addition, the number of the contact blocks as well as the number of the contact elements per contact block can deviate from the illustrated number. The individual elements of the substrate holder, especially supporting parts, have a stable core, which can be made, for example, of titanium. The core is covered or coated with a non-conductive material, such as, for example, ECTFE, PFA, or FEP.

1. Substrate holder (1) for holding substrates (5), especially semiconductor wafers, with first and second components (3,4) between which the substrate (5) can be received, characterized in that the first component (3) is provided with a base body (7) and at least one first support element (70) that is movable relative thereto and that is elastically pre-tensioned in the direction of the second component (4).

2. Substrate holder (1) according to claim 1, characterized by at least one spring (64) between base body (7) and first support element (70).

3. Substrate holder (1) according to claim 1 or 2, characterized by at least one guide element (68) for guiding the base body (7) and/or the first support element (70) during the relative movement.

4. Substrate holder (1) according to one of the preceding claims, characterized by at least one abutment that limits the relative movement between base body (7) and first support element (70).

5. Substrate holder (1) according to one of the preceding claims, characterized in that the first support element (70) is a support plate having a support surface (72) that is adapted to the substrate (5).

6. Substrate holder (1) according to claim 5, characterized in that the support surface (72) is roughened.

7. Substrate holder (1) according to one of the preceding claims, characterized by at least one second support element (70) that is movable relative to the base body (7) and to the first support element (70), and that is elastically pre-tensioned in the direction of the second component (4).

8. Substrate holder (1) according to one of the preceding claims, characterized in that the second support element (76) is movable into a first position in which its support surface (86) is disposed over the support surface (72) of the first support element (70).

9. Substrate holder (1) pursuant to one of the preceding claims, characterized in that the second support element (76) is movable into a second position in which its support surface (86) is disposed below the support surface (72) of the first support element (70).

10. Substrate holder (1) pursuant to one of the preceding claims, characterized in that the second support element (76) is guided in an opening (74) of the first support element (70).

11. Substrate holder (1) according to one of the preceding claims, characterized by a device (84) for limiting the relative movement between the second support element (76) and the base body (7) and/or the first support element (70).

12. Substrate holder (1) according to one of the preceding claims, characterized in that the support surface (86) of the second support element (76) is smaller than that of the first support element (70).

13. Substrate holder (1) according to one of the preceding claims, characterized by at least one suction opening (90) in the support surface (86) of the second support element (76).

14. Substrate holder (1) according to one of the preceding claims, characterized in that the second component (4) has a central opening that is adapted to the shape of the substrate (5).

15. Substrate holder (1) according to one of the preceding claims, characterized by a sealing element (111) that faces the substrate (5) and surrounds the central opening.

16. Substrate holder (1) according to one of the preceding claims, characterized by a locking mechanism (38) for locking the two components (3,4) of the substrate holder.

17. Substrate holder (1) according to one of preceding claims, characterized in that the locking mechanism (38) is provided with a rotatable locking element (40) on one component, and a receiving means on the other component for the receipt of the locking element.

18. Substrate holder (1) according to claim 17, characterized in that the locking element (40) is pre-tensioned via at least one spring (84) into a locking position, and is movable counter to the pre-tension via an actuating mechanism (52).

19. Substrate holder (1) according to claim 17 or 18, characterized by an inclined locking surface (130) on the locking element (40) and/or on the receiving means (120).

20. Substrate holder (1) according to one of the claims 17 to 19, characterized in that the locking element (40) is provided with at least one holding part (42) for holding and releasing the second support element (76).

21. Substrate holder (1) according to claim 20, characterized in that the second support element (76) is movable counter to its pre-tension due to relative movement between the holding part (42) and the second support element (76).

22. Substrate holder (1) according to one of the preceding claims, characterized by at least one sealing element (35) between the two components (3,4) of the substrate holder.

23. Substrate holder (1) according to one of the preceding claims, characterized by at least one contact device (134) for the electrical contacting of that surface of the substrate (5) that faces the second component (4).

24. Substrate holder (1) for holding substrates (5), especially semiconductor wafers, with first and second components (3,4) between which the substrate (5) can be received, and at least one contact element (144) for the electrical contacting of a surface of the substrate (5), which is provided with a connection end (146), a contact end (145) that is remote therefrom and overlaps the substrate (5), and a connecting portion (152) between the ends, characterized in that the connecting portion (152) is guided by a guide means (141) along the outer periphery of the substrate (5) essentially perpendicular to the substrate surface that is to be contacted, and the contact end (145) is elastically pre-tensioned in the direction of the substrate surface.

25. Substrate holder (1) according to claim 24, characterized in that the connecting portion (152) is movable parallel to the guide means (141).

26. Substrate holder (1) according to one of the claims 24 to 26, characterized in that the contact element (144) is elastic at least in a region (152) between the connection end (146) and the guide means (141).

27. Substrate holder (1) according to one of the claims 24 to 26, characterized in that the contact element (144) is carried in a base body (136) and with it forms a contact block (134).

28. Substrate holder (1) according to claim 27, characterized in that the guide means (141) is a part of the base body (136).

29. Substrate holder (1) according to claims 27 or 28, characterized by a plurality of contact elements (144) in one contact block (134).

30. Substrate holder (1) according to claim 28, characterized in that the connection ends (146) of the contact elements (144) are connected to a common contact part (148).

31. Substrate holder (1) according to one of the claims 27 to 29, characterized in that a plurality of contact blocks (134) are arranged about the outer periphery of the substrate (5).

32. Substrate holder (1) according to claim 31, characterized by two electrical lines (150,152) that are connected to contact parts (148) of the contact blocks (134) in such a way that each second contact block (134) is connected to one line (150), and the remaining contact blocks (134) are connected to the other line (152).
